(19) United States
(12) Patent Application Publication
(10) Pub. No.: US 2009/0239593 A1
(43) Pub. Date: Sep. 24, 2009

(54) MOBILE DEVICE EMPLOYING A DEPLOYABLE RFID ANTENNA

(75) Inventors: Parakrama Jayasinghe, Rajagiriya (LK); James Fagioli, Holtsville, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/050,712

(22) Filed: Mar. 18, 2008

(51) Int. Cl. H04Q 5/22; H04M 1/00

(52) U.S. Cl. 455/575.1; 340/10.1

(57) ABSTRACT

Systems, devices and/or methods that facilitate improved form factors for RFID enabled mobile devices with RFID antenna component(s) are presented. These RFID antenna component(s) can be deployable, for example, foldable, slidable, detachable, or combinations thereof, among other means of deployment. By being able to place the RFID antenna component(s) in a packed configuration and/or one or more deployed configurations, the resulting improved form factor can improve usability, reduce maintenance complexity, and facilitate improved performance. Similarly, in a deployed configuration, the resulting form factor can function in a manner equivalent to, or at an improved level over, conventional devices, systems, and/or methods with regard to aspects related to the form factor.

### TECHNICAL FIELD

The subject innovation relates generally to RFID enabled mobile devices, systems, and/or methods and more particularly to RFID enabled mobile device enclosures, systems, and/or methods employing a deployable RFID antenna to facilitate an improved form factor.

### BACKGROUND

Traditionally, radio frequency identification (RFID) enabled mobile device enclosures incorporate an integrated non-deployable RFID antenna communicatively coupled to the mobile device's internal electronics. These integrated non-deployable RFID antennas, particularly with respect to antennas such as those in EPC Class 0 and EPC Class 1 RFID access devices, are typically positioned in a static manner. For example, a commonly available configuration of the RFID antenna can be one that protrudes at an oblique or right angle from the body of the mobile device and usually at the front or top end of the mobile device, to some degree resembling an “L” shape. This oblique angle can normally be quite pronounced and frequently can approach 90 degrees (e.g., a right angle) in relation to the centerline of the mobile device body. The result can be a bulky and unwieldy RFID access device.

A conventional RFID access device (e.g., a RFID enabled mobile device with RFID antenna) that can be cumbersome as a result of the positioning of the RFID antenna can present a non-optimal form factor. This non-optimal form factor can result in more difficulty for the device user, for example, the user can have difficulty storing the device, carrying the device in normal daily activities, or using the device in a coordinated manner, among other difficulties. Additionally, these form factor related problems, when using the device for RFID sensing, can be even more frustrating when the device is being used for non-RFID sensing work. For example, where the RFID enabled mobile device is used to scan RFID tags in a delivery truck prior to walking the package to a customer's front door, the bulkiness of the protruding antenna can result in the mobile device banging into objects as it hangs from the delivery driver's hip after a RFID tag is accessed (e.g., read, written, updated, erased, queried, . . . ). Where the delivery driver, for example, needs the customer to sign on the mobile device for the package (e.g., a non-RFID related activity) the non-optimal form factor can be a hindrance or annoyance to the signing customer.

Further, where the conventional RFID antenna is employed, the antenna can frequently be integrated into the housing of the mobile deice, such that servicing the antenna can require the mobile device housing to be extensively disassembled to allow access to the antenna and connections (e.g., the mobile device housing may need to be opened to allow access to the antenna). Where the device housing must be opened, this can expose the internal electronics to possible damage or contamination. Moreover, these more invasive types of service can be more time consuming and require higher levels of skill of the service technician, and thus, can result in higher service fees or maintenance expense.

Moreover, where the antenna is integrated into the housing of an RFID enabled mobile device, the efficiency of RFID scanning, where such scanning is directional (as is frequently the case, particularly with respect to EPC Class 0 and EPC Class 1 RFID access devices and the like), can be impaired. As an example, where an antenna can be more effectively directed at the RFID scan target, less power or time can be required for scanning. Thus, where only a set amount of power is available for scanning in a mobile device, the user can be required to manipulate or orient the mobile device to more efficiently acquire RFID information in a scan. A poor form factor can make this user manipulation more difficult.

### SUMMARY

The following presents a simplified summary of the disclosed subject matter in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventional RFID enabled mobile devices with integrated RFID antennas can frequently present significant problems resulting from non-optimal form factors. In contrast, the disclosed subject matter presents RFID enabled mobile devices, systems, and methods employing deployable RFID antenna component(s) to facilitate improved form factors. A deployable RFID antenna component can be packed or deployed in one or more configurations. For example, a deployable antenna component can be packed such that the packed RFID antenna component in relation to the RFID enabled mobile device provides an improved form factor over conventional devices, systems, or methods, for non-RFID mobile device applications employing an RFID enabled mobile device. This packed RFID antenna configuration can then be transitioned to a deployed configuration to facilitate RFID related mobile device applications. Further, the deployed configuration (e.g., the RFID enabled mobile device with RFID antenna in a deployed configuration) can present an equivalent or improved form factor over conventional devices, systems, or methods. These improved form factors can facilitate, for example, greater ease of use and/or storage, reduced maintenance burden, and improved efficiency of use with respect to conventional devices.

To the accomplishment of the foregoing and related ends, the disclosed subject matter, then, comprises the features hereinafter fully described and particularly pointed out in the claims. The following description and the annexed drawings set forth in detail certain illustrative embodiments of the disclosed subject matter. These embodiments can be indicative, however, of but a few of the various ways in which the principles of the disclosed subject matter can be employed. Other objects, advantages, and novel features of the disclosed subject matter will become apparent from the following detailed description of the disclosed subject matter when considered in conjunction with the drawings.

### BRIEF DESCRIPTION OF THE DRAWINGS

FIG. 1 is a diagram of a system that can facilitate an improved form factor for a RFID enabled mobile device in accordance with an aspect of the subject matter disclosed herein.

FIG. 2 is a diagram of a system that can facilitate an improved form factor for a RFID enabled mobile device in accordance with an aspect of the subject matter disclosed herein.

FIG. 3 is a diagram of a system that can facilitate an improved form factor for a RFID enabled mobile device in accordance with an aspect of the subject matter disclosed herein.

FIG. 4 is a diagram of a system that can facilitate an improved form factor for a RFID enabled mobile device in accordance with an aspect of the subject matter disclosed herein.

FIG. 5 is a diagram of a system that can facilitate an improved form factor for a RFID enabled mobile device in accordance with an aspect of the subject matter disclosed herein.

FIG. 6 is a schematic illustration of a system that can facilitate an improved form factor for a RFID enabled mobile device in accordance with an aspect of the subject matter disclosed herein.

FIG. 7 is a schematic illustration of a system that can facilitate an improved form factor for a RFID enabled mobile device in accordance with an aspect of the subject matter disclosed herein.

FIG. 8 is a schematic illustration of a system that can facilitate an improved form factor for a RFID enabled mobile device in accordance with an aspect of the subject matter disclosed herein.

FIG. 9 illustrates a methodology that can facilitate an improved form factor for a RFID enabled mobile device in accordance with an aspect of the subject matter disclosed herein.

FIG. 10 illustrates a methodology that can facilitate an improved form factor for a RFID enabled mobile device in accordance with an aspect of the subject matter disclosed herein.

FIG. 11 illustrates a methodology that can facilitate an improved form factor for a RFID enabled mobile device in accordance with an aspect of the subject matter disclosed herein.

FIG. 12 illustrates a methodology that can facilitate an improved form factor for a RFID enabled mobile device in accordance with an aspect of the subject matter disclosed herein.

FIG. 13 illustrates a methodology that can facilitate an improved form factor for a RFID enabled mobile device in accordance with an aspect of the subject matter disclosed herein.

FIG. 14 illustrates a block diagram of an exemplary electronic device that can utilize the improved form factor for a RFID enabled mobile device in accordance with an aspect of the subject matter disclosed herein.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the disclosed subject matter. It is evident, however, that the disclosed subject matter can be practiced without these specific details. In other instances, well-known structures and devices are shown in block diagram form in order to facilitate describing the subject innovation.

Conventionally, RFID access devices can be handheld devices with RFID antennas molded into the device to provide a device for accessing (e.g., read, write, update, erase, query, . . . ) other RFID components. These RFID access devices typically can have the RFID antenna portion of the device disposed at an oblique or right angle to the main body of the access device and result in a bulky and cumbersome RFID enabled mobile device, particularly when the device is not exclusively used for RFID access applications (e.g., read, write, update, erase, query, . . . ).

Further, conventional RFID access devices can generally employ a housing which encloses both the mobile device and the disposed RFID antenna. This common approach to incorporating the RFID antenna into the RFID access device can present increased complexity for servicing of the RFID antenna. This can include risking contamination or damage to the sensitive electronic components of the mobile device as the RFID antenna is serviced because the encompassing housing may need to be removed. It can further include requiring additional servicing time and expertise to access the RFID components inside the more bulky housing for the mobile device and the RFID antenna.

Moreover, where RFID antennas can be directional, the bulk of the RFID antenna disposed at an oblique or right angle can hinder efficient accessing of RFID tags in real world situations by requiring the user to manipulate the RFID access device into more efficient positions. Where conventional devices already tend towards bulkier dimensions, this can put additional strain on a user.

In contrast to conventional devices and in accordance with an aspect of the disclosed subject matter, a deployable RFID antenna component can improve the form factor of a RFID enabled mobile device. The deployable RFID antenna component can be in a packed configuration to provide a more optimal form factor (e.g., a packed configuration) when the RFID capabilities of the RFID enabled mobile device are not needed. Further, the RFID antenna can be deployed into one or more deployed configurations when the RFID capabilities of the RFID enabled mobile device are needed. Additionally, in the deployed configuration(s), the deployable antenna can provide an equivalent or improved form factor over conventional RFID access devices.

In accordance with another aspect of the disclosed subject matter, an inferential or intelligent component can be employed to form inferences related to deploying or packing the deployable RFID antenna component(s). Based at least in part on these inferences, the deployable RFID antenna component(s) can be articulated into a packed or deployed configuration. For example, where the deployable RFID antenna component is motorized, an inference can be formed, for example based on the user's historic activities and the presence of an RFID tag, such that the RFID antenna can automatically articulate itself into the optimal deployed position to efficiently access a relevant RFID tag, based at least in part on the formed inference. Similarly, for example, where a motorized, slideably deployable RFID antenna component determines that it is being removed from a holster, it can infer, based on being removed from the holster, that RFID components are likely to be accessed such that, based at least in part on that inference, the RFID antenna can be deployed from a packed configuration automatically. One of skill in the art will appreciate that a nearly limitless number of inferences can be formed, from the very basic to highly complex, and that all such inferences are to be considered within the scope of the herein disclosed subject matter. A more detailed discussion of artificial intelligence, intelligent agents, and inferences is presented herein.

The deployable RFID antenna component(s) (hereinafter “DRFID”) can be in a packed configuration. The packed configuration is generally employed when the RFID enabled mobile device (hereinafter “RFIDMD”) is not being employed for RFID related applications. For example, a grocery clerk can use a RFIDMD to create warehouse orders for restocking of sold products. The exemplary RFIDMD can have the DRFID in a packed configuration, for example, when the RFIDMD is in a charging cradle, when it is in a hip holster, when it is being employed for looking up product information by SKU number, when it is being used for order review, or combinations thereof, among numerous other examples of when the RFIDMD can be used in a non-RFID related application. By placing the DRFID in a packed configuration, the DRFID can be “out of the way” allowing an improved form factor in comparison to more conventional devices which can have the RFID antenna in a static position as discussed herein.

In an aspect of the disclosed subject matter, the packed configuration of the DRFID can include a foldably deployed DRFID folded into a more compact configuration, a slidably deployed DRFID with the DRFID slid into a more compact configuration, a removable DRFID with the DRFID removed from the RFIDMD, or combinations thereof, among other more compact configurations for other deployment modalities. In general, the packed configuration can be considered a storage configuration for the DRFID such that the RFIDMD has an improved form factor enabling a user to employ the RFIDMD in a more efficient, comfortable, and/or optimal manner. As will be appreciated by one of skill in the art, the packed configuration does not require that the DRFID be configured in the most compact fashion or represent the smallest form factor, and that any configuration that is determined to be more optimal than having the DRFID in a deployed configuration can be considered a packed configuration and thus is within the scope of the disclosed subject matter. For example, folding the DRFID flat against the back of the RFIDMD (e.g., like a closed pen knife) can be a packed configuration that has a very compact form factor. However, also for example, extending the DRFID so that it is parallel with the RFIDMD body (e.g., like an open pen knife) can be a packed configuration even though this is not the most compact form factor possible, where, for example, the RFIDMD can now more easily fit in a hip holster.

In a related aspect, a deployed configuration can include any configuration that is not the packed configuration. For example, the deployed configuration can include connecting a detachable DRFID to the RFIDMD, folding out the DRFID, sliding into an extended position the DRFID, or combinations thereof, among other configurations for other deployment modalities. Similarly, there can be more than one deployed position, for example, extending a foldable DRFID to 30, 60, 90, 120, 150, or 180 degrees (among all other angles); rotating the DRFID around an additional axis or degree of freedom, or any of a nearly limitless number of other deployed configurations, all of which are considered within the scope of the disclosed subject matter. Generally, a deployed configuration places the DRFID in a position to function effectively as an RFID antenna. The deployed position can be of a similar form factor, or can provide an improved form factor, over conventional RFID access devices with integrated RFID antennas.

In another aspect, the configuration of the DRFID can be related to improving non-form factor RFIDMD performance, for example, by conserving battery capacity. The packed configuration, for example, can indicate that the DRFID is not in use (e.g., not scanning for RFIDs) and thus power to the DRFID need not be expended. Thus, placing the DRFID in packed position can cause power to the DRFID to be reduced or turned off. Similarly, for example, deploying the DRFID can indicate that power should be applied to the DRFID. However, this power saving aspect is not required to practice the disclosed subject matter and the configuration need not be explicitly or directly associated with the functionality, or lack thereof, of the DRFID. Thus, one of skill in the art will appreciate that the DRFID can be, for example, turned on and/or off independent of, or coordinated with, the packed and/or a deployed configuration. One of skill in the art will further appreciate that other functionality can be related to the current configuration or change in configuration of the DRFID to improve non-form factor related performance of the RFIDMD.

The subject innovation is hereinafter illustrated with respect to one or more arbitrary systems for performing the disclosed subject matter. However, it will be appreciated by one of skill in the art that one or more aspects of the subject innovation can be employed in other RFID enabled systems and is not limited to the examples herein presented.

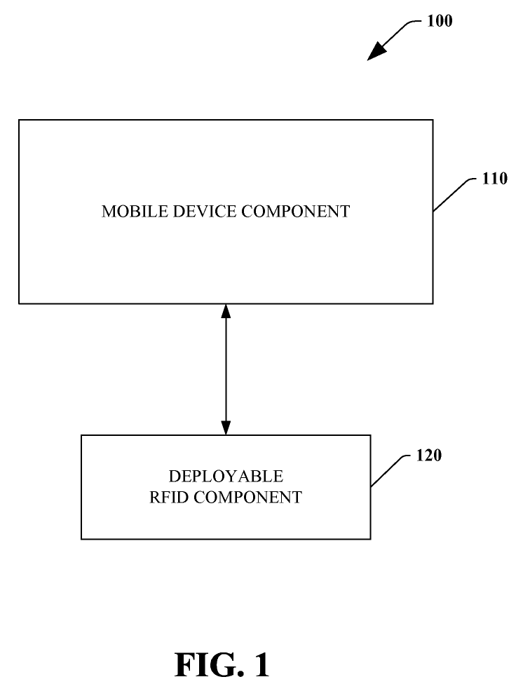

Turning to FIG. 1, illustrated is a system 100 that can facilitate an improved form factor for a RFID enabled mobile device in accordance with an aspect of the subject matter disclosed herein. System 100 can include a mobile device component 110. The mobile device component 110 can be enabled for RFID applications or can support RFID applications when communicatively coupled to additional components (not illustrated). For example, the mobile device component 110 can be a personal digital assistant (PDA) with integrated RFID capability, a PDA that supports RFID capabilities by inserting a compact flash card (or any other expansion component, as will be appreciated by one of skill in the art), a cellular phone with RFID capabilities, a custom handheld computer platform device (e.g., a UPS-type or FedEx-type handheld device, or other customized mobile RFID access device) that supports RFID capabilities, warehouse scanners, restocking/order devices, or any of a nearly limitless number of other mobile electronic devices that are germane to RFID capabilities, either natively or by addition or alteration of accessory components.

The mobile device component 110 can be communicatively coupled to a DRFID 120 (e.g., a deployable RFID component). The DRFID component 120 can comprise at least an RFID antenna. The DRFID component 120 can further comprise other RFID components (not illustrated, e.g., RFID device drivers, radios, signal processors, power components, . . . ). The DRFID component 120 can function in conjunction with the mobile device component 110 and/or additional components (not illustrated) to form a RFID access device (e.g., a RFIDMD). The DRFID 120 can be deployable and packable, as herein described, to facilitate an improved form factor for the system 100.

In accordance with an aspect, the DRFID component 120 of system 100 can be at least one of: foldably, slidably, or detachably deployable in relation to mobile device component 110. A foldably deployable DRFID component 120 can, for example, be folded into a more optimal form factor as a packed configuration and unfolded into a deployed configuration to support RFID applications. The deployed configuration can present an equivalent or improved form factor over conventional devices. A slidably deployable DRFID component 120 can, for example, be slid into a more optimal form factor as a packed configuration, for example slid into a “closed” form factor, among other slidable configurations. Moreover, the slidably deployable DRFID component 120 can be slid into a deployed configuration, for example slid into an “open” form factor, to support RFID applications. The deployed configuration can present an equivalent or improved form factor over conventional devices. A detachably deployable DRFID component 120 can be detached from the mobile device component 110 as a packed configuration having an improved form factor (e.g., the DRFID component 120 can be stored or carried separate from the mobile device component 110). The detachably deployable DRFID component 120 can be attached to the mobile device component 110 to support RFID applications. The deployed configuration can present an equivalent or improved form factor over conventional devices.

One of skill in the art will appreciate that a nearly limitless number of deployment modalities are possible and these generally are highly dependent upon the particular RFID application. While it is not possible to describe every possible deployment modality, it will further be appreciated by one of skill in the art that all such deployment modalities having at least a deployed configuration and a packed configuration are within the scope of the disclosed subject matter. Further, the disclosed subject matter includes deployed and packed configurations incorporating additional manipulations such as, but not limited to, rotation or articulation about at least an additional axis or degree of freedom, articulation of multiple segments forming a DRFID component 120, or combinations of a plurality of deployment modalities.

In an aspect, a deployment modality can include automated deployment and/or packing. For example, the DRFID component 120 can include a motorized component (not illustrated) that can automatically transition the DRFID component 120 to a packed or deployed configuration. In addition, automated deployment and/or packing can be facilitated by incorporating an intelligent component that can, at least in part, form inferences relating to deployment and/or packing configurations. These inferences can be based on a nearly limitless number of factors that can include, as non-limiting examples, user identification, user history, user profile, spatial location, acceleration, time of day, day of week, temperature, weather, proximity to an object (e.g., a charger, a holster, a RFID tag, another RFID access device, an interference source, . . . ), or combinations thereof among many other factors. These factors can be employed to form an inference related to deploying or packing the DRFID component 120.

As an example, the intelligent component can form an inference that the DRFID component 120 should be deployed when a delivery driver stops at a house (e.g., by GPS location cross referenced to scheduled delivery locations) and unholsters the RFIDMD. The inference can be employed to at least in part cause the deployment of the DRFID component 120. After RFID tags have been acquired, an inference can be formed that the DRFID component 120 should be packed (e.g., the RFIDs for the correct number of packages to be delivered to that particular address have been scanned) and the inference can, at least in part, cause the DRFID component 120 to be articulated into a packed configuration. One of skill in the art will appreciate that numerous other examples of incorporating inferences into determinations and actions relating to deployment modalities are feasible and that all such use of inferences is to be considered within the scope of the disclosed subject matter.

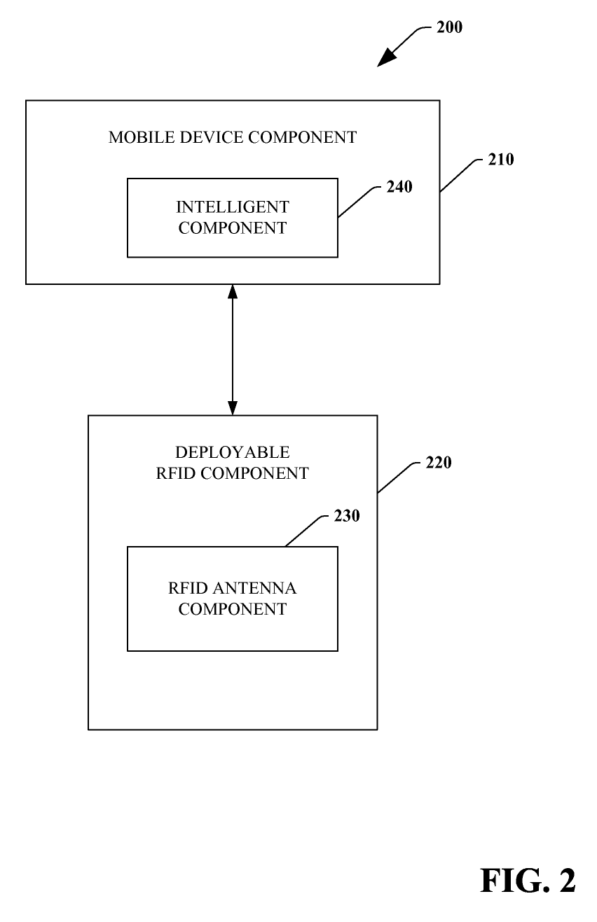

Turning to FIG. 2, illustrated is a system 200 that can facilitate an improved form factor for a RFID enabled mobile device in accordance with an aspect of the subject matter disclosed herein. System 200 can include a mobile device component 210 that can be the same as, or similar to, mobile device component 110. Mobile device component 210 can be communicatively coupled to DRFID component 220 which can be the same as, or similar to, DRFID component 120. DRFID component 220 can further include an RFID antenna component 230. The RFID antenna component 230 can be any RFID antenna that is appropriate to the particular RFID application for which the RFIDMD is intended. RFID antenna component 230 can be the same as, or similar to, a RFID antenna found in a conventional RFID access device as herein discussed. Thus, the deployment modality is not dependent upon the actual structure of the RFID antenna component 230, but rather can be distinguished as the structure and/or method for deploying a RFID antenna component 230. Where the deployment modality can be more optimal by employing a specific RFID antenna component 230 (e.g., different than a conventional RFID antenna) such specific RFID antenna component 230 can be employed. Similarly, where the deployment modality can be effected with well known RFID antenna components 230 (e.g., such as those currently used in conventional RFID access devices), these well known RFID antenna components 230 can be employed.

System 200 can further comprise an intelligent component 240, as herein described. Intelligent component 240 is illustrated within the mobile device component 210 in FIG. 2. One of skill in the art will appreciate that the intelligent component 240 can be included in, or distributed amongst, any and all components of system 200 where germane to forming a RFIDMD. The placement of the intelligent component 240 is thus not limited to inclusion in the mobile device component 210 as illustrated solely for ease of understanding. The intelligent component 240 can, at least in part, form inferences relating to the deployment and/or packing of the DRFID component 220 as discussed herein.

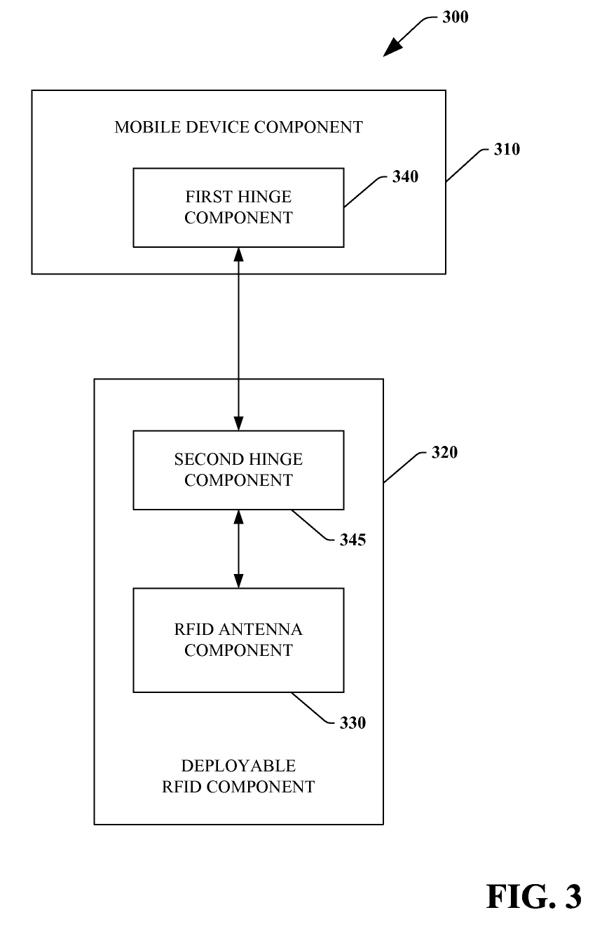

FIGS. 3-5 illustrate non-limiting exemplary systems in accordance with the disclosed subject matter to facilitate a more clear understanding of the several aspects of the disclosed subject matter. Turning to FIG. 3, illustrated is a system 300 that can facilitate an improved form factor for a RFID enabled mobile device in accordance with an aspect of the subject matter disclosed herein. System 300 can include a mobile device component 310 that can be the same as, or similar to, mobile device component 110, 210. The system 300 can further include DRFID component 320 that can be the same as, or similar to, DRFID 120, 220. DRFID component 320 can further include an RFID antenna component 330 that can be the same as, or similar to, RFID antenna component 230.

The mobile device component 310 can include a first hinge component 340 that can be deployably coupled to the DRFID component 320 by way of an included second hinge component 345. The deployment and/or packing of the DRFID component to facilitate improved form factors can be by way of the first hinge component 340 and second hinge component 345. The hinge components (e.g., 340 and 345) can facilitate, for example, folding the DRFID component 320 against (e.g., packing) the mobile device component 310 (e.g., similar to a closed pen knife as herein described) providing a more compact form factor than that found in typical conventional RFID access devices. Similarly, the hinge components (e.g., 340 and 345) can facilitate, for example, folding the DRFID component 320 outward (e.g., deploying) from the mobile device component 310 (e.g., similar to an open pen knife as herein described). The deployed DRFID component 320 can have an equivalent or improved form factor over conventional RFID access devices as herein described.

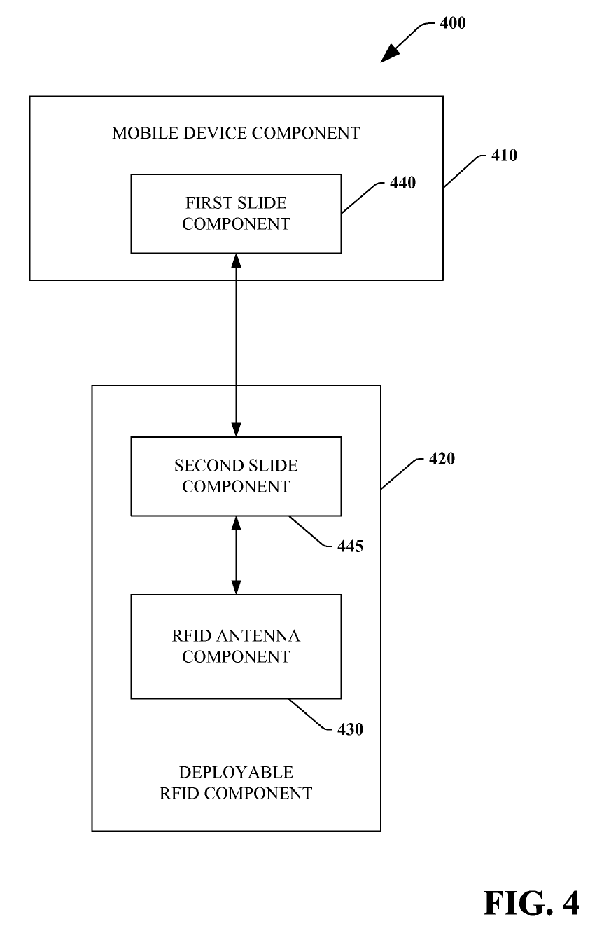

Turning to FIG. 4, illustrated is a system 400 that can facilitate an improved form factor for a RFID enabled mobile device in accordance with an aspect of the subject matter disclosed herein. System 400 can include a mobile device component 410 that can be the same as, or similar to, mobile device component 110, 210. The system 400 can further include DRFID component 420 that can be the same as, or similar to, DRFID 120, 220. DRFID component 420 can further include an RFID antenna component 430 that can be the same as, or similar to, RFID antenna component 230.

The mobile device component 410 can include a first slide component 440 that can be deployably coupled to the DRFID component 420 by way of an included second slide component 445. The deployment and/or packing of the DRFID component to facilitate improved form factors can be by way of the first slide component 440 and second slide component 445. The slide components (e.g., 440 and 445) can facilitate, for example, sliding the DRFID component 420 into a “closed” configuration (e.g., packing) with the mobile device component 410 providing a more compact form factor than that found in typical conventional RFID access devices. Similarly, the slide components (e.g., 440 and 445) can facilitate, for example, sliding the DRFID component 420 into an “open” configuration (e.g., deploying) with the mobile device component 410. The deployed DRFID component 420 can have an equivalent or improved form factor over conventional RFID access devices as herein described.

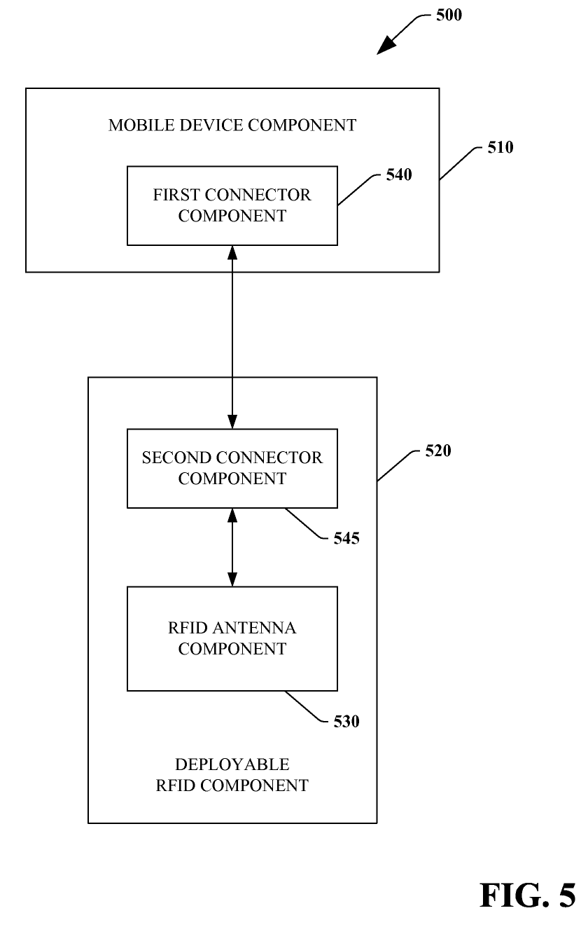

Turning to FIG. 5, illustrated is a system 500 that can facilitate an improved form factor for a RFID enabled mobile device in accordance with an aspect of the subject matter disclosed herein. System 500 can include a mobile device component 510 that can be the same as, or similar to, mobile device component 110, 210. The system 500 can further include DRFID component 520 that can be the same as, or similar to, DRFID 120, 220. DRFID component 520 can further include an RFID antenna component 530 that can be the same as, or similar to, RFID antenna component 230.

The mobile device component 510 can include a first connector component 540 that can be deployably coupled to the DRFID component 520 by way of an included second connector component 545. The deployment and/or packing of the DRFID component to facilitate improved form factors can be by way of the first connector component 540 and second connector component 545. The connector components (e.g., 540 and 545) can facilitate, for example, disconnecting the DRFID component 520 from the mobile device component 510 (e.g., packing) providing a more compact form factor than that found in typical conventional RFID access devices (e.g., removing the DRFID can be an improved from factor as compared to having the RFID antenna still attached as in conventional devices). Similarly, the connector components (e.g., 540 and 545) can facilitate, for example, interconnecting the DRFID component 520 with the mobile device component 510 (e.g., deploying). The deployed DRFID component 520 can have an equivalent or improved form factor over conventional RFID access devices as herein described.

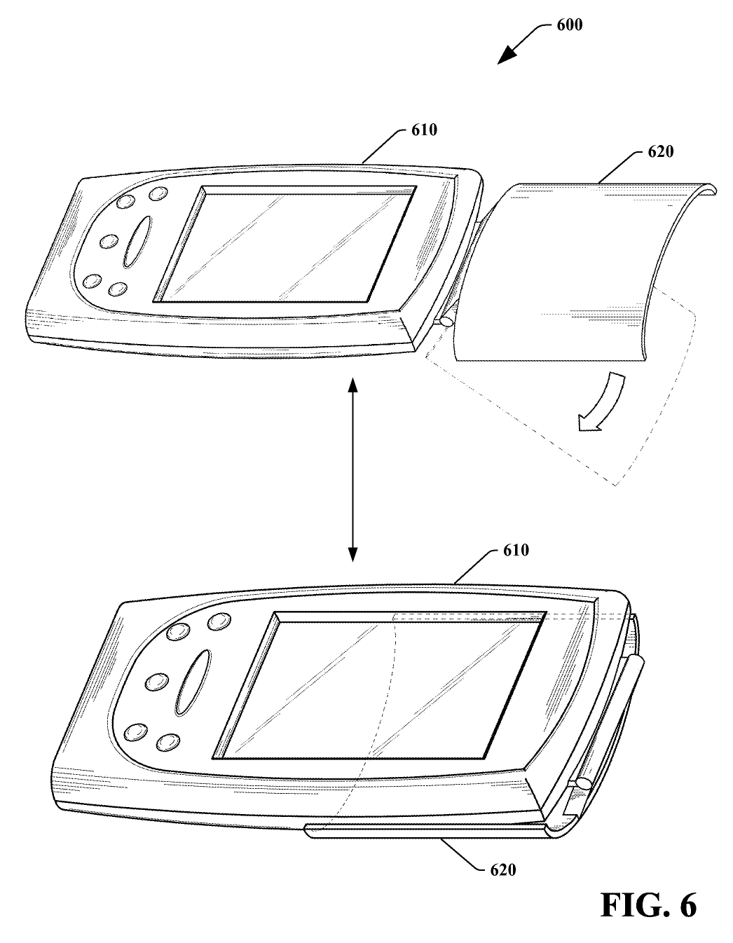

FIGS. 6-8 illustrate non-limiting exemplary devices in accordance with the disclosed subject matter to facilitate a more clear understanding of the several aspects of the disclosed subject matter. Turning to FIG. 6, illustrated is a schematic illustration of a system 600 that can facilitate an improved form factor for a RFID enabled mobile device in accordance with an aspect of the subject matter disclosed herein. System 600 can include a mobile device component 610 that can be the same as, or similar to, mobile device component 110, 210, 310. The system 600 can further include DRFID component 620 that can be the same as, or similar to, DRFID 120, 220, and 320. As will be appreciated by one of skill in the art from the illustration, system 600 permits transitioning between a deployed (top illustration) and a packed (bottom illustration) configuration. As compared to conventional RFID access devices, which can be bulky and cumbersome as herein discussed, it is clear that the packed configuration can be a substantially improved form factor. Similarly, the deployed configuration can also represent an improved form factor over the conventional RFID access device. While the illustration depicts the packed configuration as folded flat against the back of the mobile device 610, it will be appreciated that numerous other packed configurations are possible as herein discussed. Additionally, while the DRFID 620 is depicted as concave in the illustration, as is typical of a EPC Class 0 or 1 RFID antenna, the disclosed subject matter is not so limited. For example, the DRFID 620 can be flat, concave, convex, or of a more complex shape wherein that shape is germane to RFID applications.

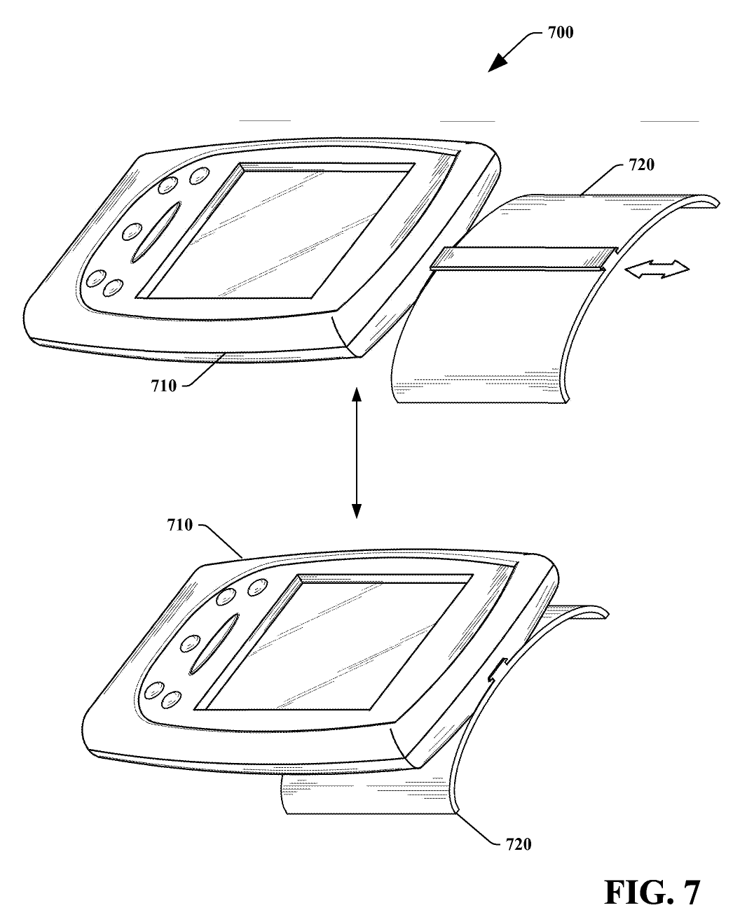

Turning to FIG. 7, illustrated is a schematic illustration of a system 700 that can facilitate an improved form factor for a RFID enabled mobile device in accordance with an aspect of the subject matter disclosed herein. System 700 can include a mobile device component 710 that can be the same as, or similar to, mobile device component 110, 210, 410. The system 700 can further include DRFID component 720 that can be the same as, or similar to, DRFID 120, 220, and 420. As will be appreciated by one of skill in the art from the illustration, system 700 permits transitioning between a deployed (top illustration) and a packed (bottom illustration) configuration. As compared to conventional RFID access devices, which can be bulky and cumbersome as herein discussed, it is clear that the packed configuration can be a substantially improved form factor. Similarly, the deployed configuration can also represent an improved form factor over the conventional RFID access device. While the illustration depicts the packed configuration as slid into a “closed” configuration against the back of the mobile device 710, it will be appreciated that numerous other packed configurations are possible as herein discussed. Additionally, while the DRFID 720 is depicted as concave in the illustration, the disclosed subject matter is not so limited, as herein discussed.

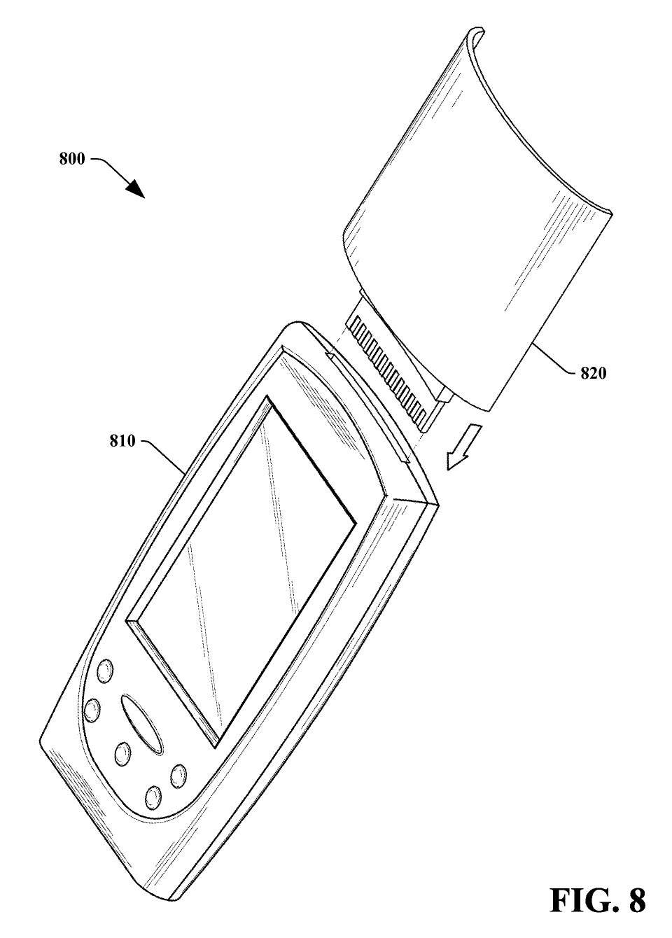

FIG. 8 illustrated is a schematic illustration of a system 800 that can facilitate an improved form factor for a RFID enabled mobile device in accordance with an aspect of the subject matter disclosed herein. System 800 can include a mobile device component 810 that can be the same as, or similar to, mobile device component 110, 210, 510. The system 800 can further include DRFID component 820 that can be the same as, or similar to, DRFID 120, 220, and 520. As will be appreciated by one of skill in the art from the illustration, system 800 permits transitioning between a deployed (e.g., with DRFID component 820 interconnected) and a packed (e.g., with DRFID component 820 disconnected) configuration. As compared to conventional RFID access devices, which can be bulky and cumbersome as herein discussed, it is clear that the packed configuration can be a substantially improved form factor. Similarly, the deployed configuration can also represent an improved form factor over the conventional RFID access device. Additionally, while the DRFID 820 is depicted as concave in the illustration, the disclosed subject matter is not so limited, as herein discussed.

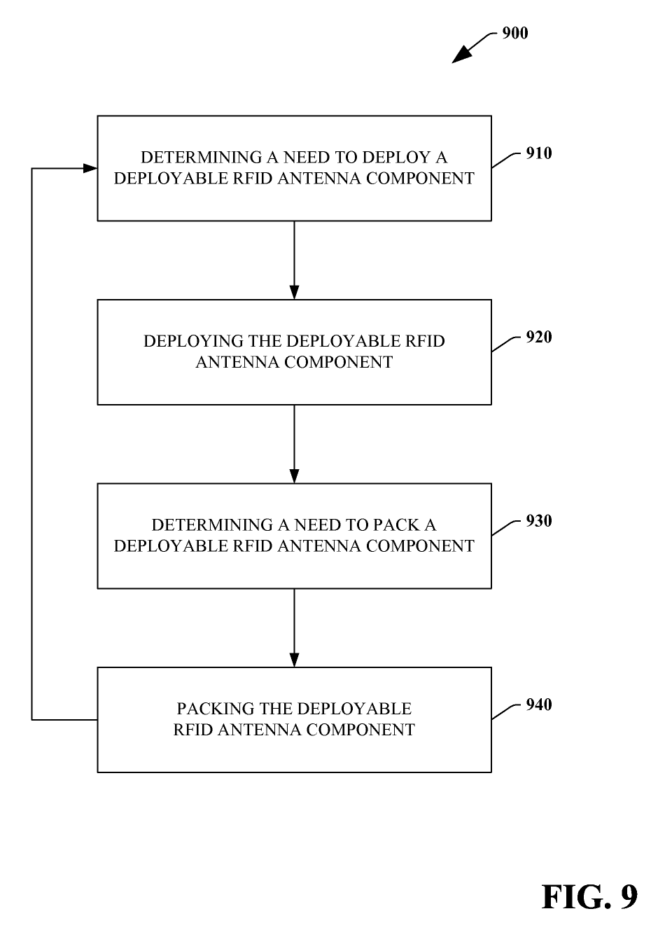

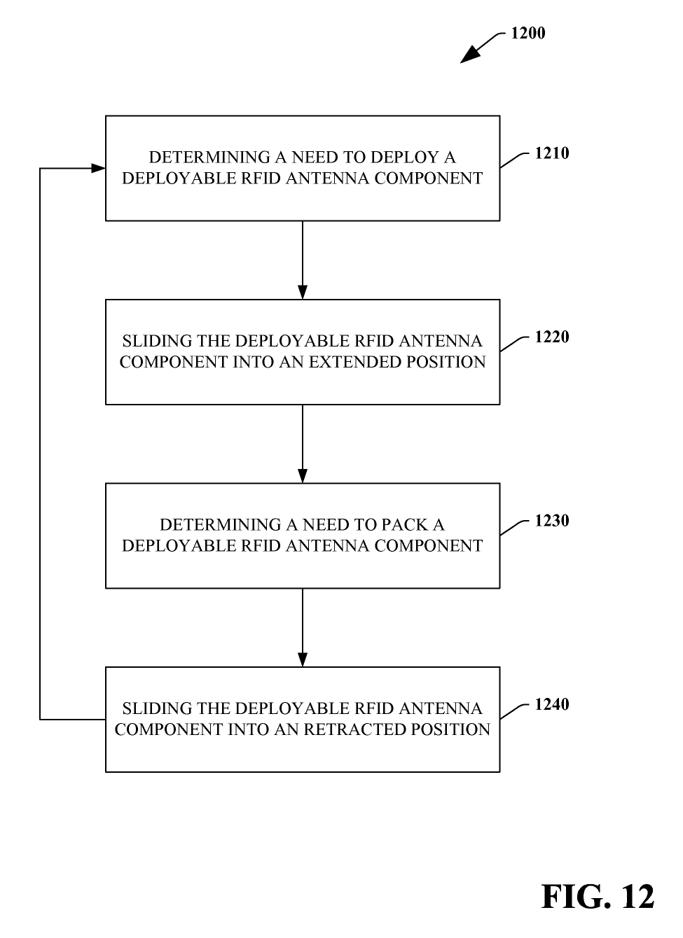

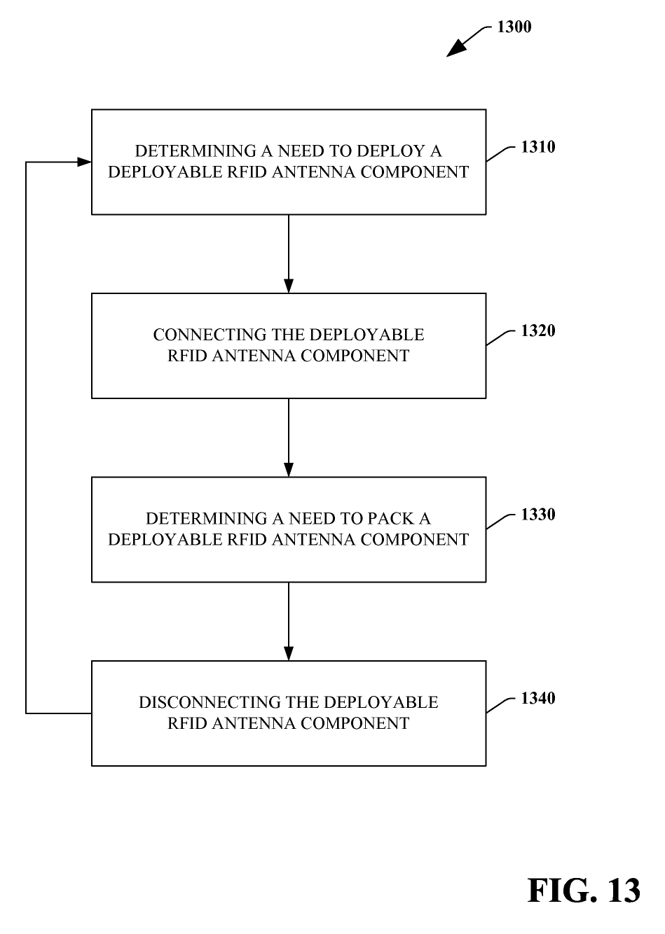

FIGS. 9-13 illustrate methodologies in accordance with the disclosed subject matter. For simplicity of explanation, the methodologies are depicted and described as a series of acts. It is to be understood and appreciated that the disclosed subject matter is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter.

Conventional methodologies generally do not contemplate deployment modalities for RFID antennas because in conventional RFID access devices the RFID antenna is generally in a fixed configuration and can be molded into the body of the RFID access device. In contrast, the disclosed subject matter relates to improving form factors by employing DRFIDs.

Referring now to FIG. 9, illustrated is a methodology 900 that can facilitate an improved form factor for a RFID enabled mobile device in accordance with an aspect of the subject matter disclosed herein. At 910, a need to deploy a DRFID can be determined. For example, in a simple design, a user can decide that the DRFID needs to be deployed to scan RFID tags. As a second example, in a more complex design, a determination can be formed by tracking application software and user input, for example, where a user pulls a trigger on a mechanical interface while in a RFID scanning software application, it can be determined that the DRFID should be deployed to scan for RFID tags.

At 920, a DRFID can be deployed. Deploying the DRFID can be based at least in part on the determination made at 910. For example, if the user determined that the DRFID should be deployed, the user can initiate the deployment of the DRFID, for example, by selecting a ‘deploy’ button or by manually deploying the DRFID, among numerous other mechanisms for initiating the deployment of the DRFID. At this point, methodology 900 can continue or end.

At 930, a need to pack a DRFID can be determined. For example, in a simple design, a user can decide that the DRFID needs to be packed to holster the RFIDMD. As a second example, in a more complex design, a determination can be formed by tracking application software and user input, for example, where a user transitions from a RFID scanning software application to an order review software application, it can be determined that the DRFID should be packed.

At 940, a DRFID can be packed. Packing the DRFID can be based at least in part on the determination made at 930. For example, if the user determined that the DRFID should be packed, the user can initiate the packing of the DRFID, for example, by selecting a ‘pack’ button or by manually packing the DRFID, among numerous other mechanisms for initiating the deployment of the DRFID. At this point, methodology 900 can continue or end.

One of skill in the art will appreciate that this methodology is generally cyclic in that a determination to deploy the DRFID while the DRFID is already deployed generally results in no changes. Similarly, a determination to pack the DRFID while the DRFID is already packed generally will result in no changes. However, the determinations can be tracked to further improve the optimization of determinations at 910 and 930. For example, where multiple determinations to pack the DRFID occur in sequence, it can indicate, for example, that computation of the determination can be improved by tracking sequences of events rather than singular criteria. Moreover, one of skill in the art will appreciate that the method can be entered at numerous entry points and exited at numerous exit points that are not illustrated for ease of understanding (e.g., the method can be entered when the RFIDMD is either packed, deployed, or in a transitory state without departing from the disclosed subject matter; the method can exit after a determination, after a packing or deployment, or in a transitory state without departing from the disclosed subject matter) and should be considered a robust methodology.

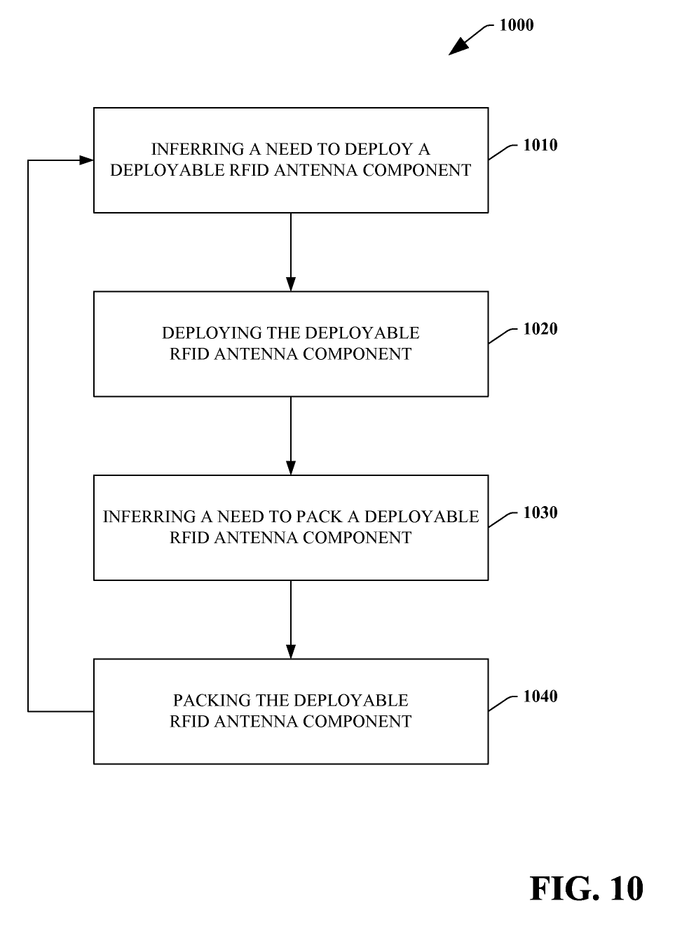

Referring now to FIG. 10, illustrated is a methodology 1000 that can facilitate an improved form factor for a RFID enabled mobile device in accordance with an aspect of the subject matter disclosed herein. At 1010 of methodology 1000, a need to deploy a DRFID can be inferred. For example, an inference can be formed based on a pharmacist removing the RFIDMD from a holster while in the proximity of the prescription drug store room that the pharmacist is likely to want to scan in RFID tags from various medications and that deploying the DRFID is a probable course of action. At 1020, a DRFID can be deployed, based at least in part on the inference made at 1010. At this point, methodology 1000 can continue or end.

At 1030, a need to pack a DRFID can be inferred. For example, when a RFIDMD has been sitting idle for an amount of time that is associated with a sufficient probability that the RFIDMD will not be used for an extended period of time (e.g., inferences can be based on other inferences as herein discussed), it can be determined that the DRFID should be packed (e.g., if a RFIDMD is left in a delivery truck at the end of a shift, the RFIDMD can infer that the DRFID can be packed to, for example, prevent damage, conserve power, . . . ). At 1040, a DRFID can be packed, based at least in part on the inference made at 1030. At this point, methodology 1000 can continue or end. Similar to the discussion of methodology 900, one of skill in the art will appreciate that methodology 1000 is generally cyclic and can be entered or exited at numerous points without departing from the spirit of the disclosed subject matter.

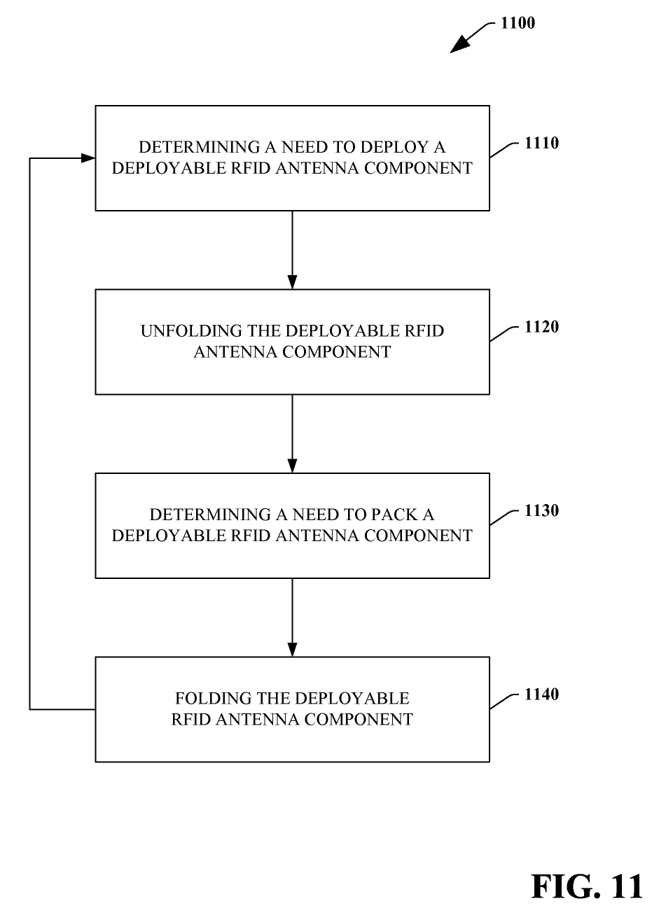

FIGS. 11-13 illustrate non-limiting exemplary methodologies in accordance with the disclosed subject matter to facilitate a more clear understanding of the several aspects of the disclosed subject matter. For conciseness of disclosure these methodologies (e.g., 1100, 1200, and 1300) are disclosed together. Referring now to FIGS. 11, 12, and 13, illustrated are methodologies 1100, 1200, and 1300, respectively, that can facilitate an improved form factor for a RFID enabled mobile device in accordance with aspects of the subject matter disclosed herein. At 1110 of methodology 1100, 1210 of methodology 1200, and 1310 of methodology 1300, a need to deploy a DRFID can be determined as herein discussed. At 1120 of methodology 1100, a DRFID can be unfolded (e.g., foldably deployed), based at least in part on the determination made at 1110. At this point, methodology 1100 can continue or end. At 1220 of methodology 1200, a DRFID can be slid into an “open” configuration (e.g., slidably deployed), based at least in part on the determination made at 1210. At this point, methodology 1200 can continue or end. At 1320 of methodology 1300, a DRFID can be interconnected (e.g., connectively deployed), based at least in part on the determination made at 1310. At this point, methodology 1300 can continue or end.

At 1130 of methodology 1100, 1230 of methodology 1200, and 1330 of methodology 1300, a need to pack a DRFID can be determined, as discussed herein. At 1140 of methodology 1100, a DRFID can be folded (e.g., foldably packed), based at least in part on the determination made at 1130. At this point, methodology 1100 can continue or end. At 1240 of methodology 1200, a DRFID can be slid into a “closed” configuration (e.g., slidably packed), based at least in part on the determination made at 1230. At this point, methodology 1200 can continue or end. At 1340 of methodology 1300, a DRFID can be disconnected (e.g., connectively packed), based at least in part on the determination made at 1330. At this point, methodology 1300 can continue or end.

Similar to the discussion of methodology 900, one of skill in the art will appreciate that methodologies 1100, 1200, and 1300, are generally cyclic and can be entered or exited at numerous points without departing from the spirit of the disclosed subject matter. Further, one of skill in the art will appreciate that while these methodologies (e.g., 1100, 1200, and 1300) are discussed in terms of determinations, inferences can also be employed as discussed in reference to methodology 1000, without departing form the spirit of the herein disclosed subject matter.

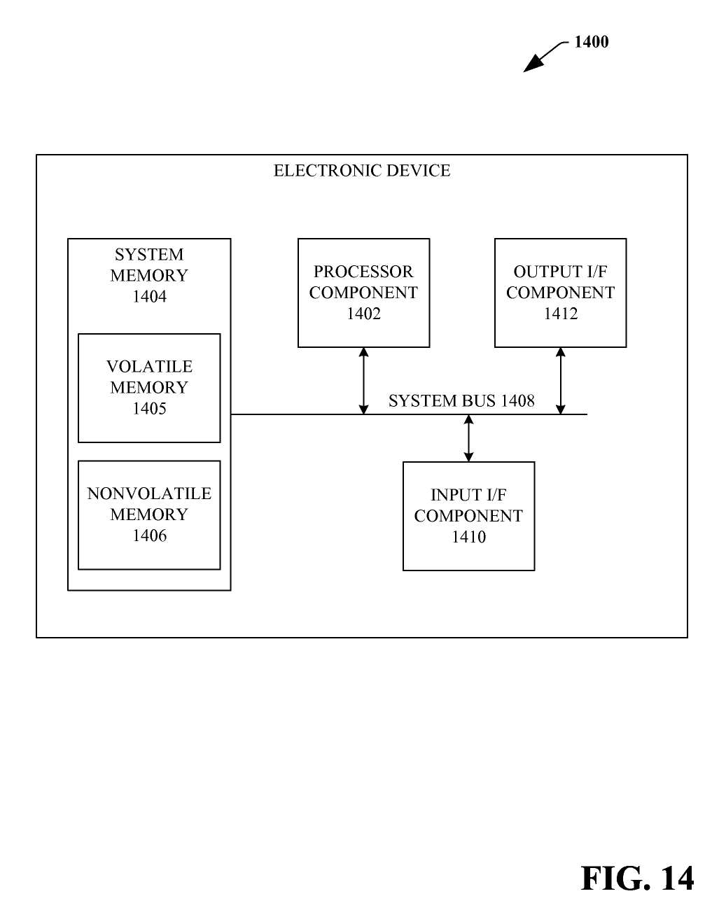

Turning to FIG. 14, illustrated is a block diagram of an exemplary electronic device that can utilize the improved form factor for a RFID enabled mobile device in accordance with an aspect of the subject matter disclosed herein. The electronic device 1400 can include, but is not limited to, a computer, a laptop computer, network equipment (e.g. routers, access points), a handled RFID access device, a portable RFID access device, a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1400 can include, but are not limited to, a processor component 1402, a system memory 1404 (with volatile memory 1405 or nonvolatile memory 1406), and a system bus 1408 that can couple various system components including the system memory 1404 to the processor component 1402. The system bus 1408 can be any of various types of bus structures including a memory bus or memory controller, a peripheral bus, or a local bus using any of a variety of bus architectures.

Electronic device 1400 can typically include a variety of computer readable media. Computer readable media can be any available media that can be accessed by the electronic device 1400. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, volatile memory 1405, nonvolatile memory 1406 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1400. Communication media typically can embody computer readable instructions, data structures, program modules or other data in a modulated data signal such as a carrier wave or other transport mechanism and includes any information delivery media.

The system memory 1404 can include computer storage media in the form of volatile 1405 and/or nonvolatile memory 1406. A basic input/output system (BIOS), containing the basic routines that help to transfer information between elements within electronic device 1400, such as during start-up, can be stored in memory 1404. Memory 1404 can typically contain data and/or program modules that can be immediately accessible to and/or presently be operated on by processor component 1402. By way of example, and not limitation, system memory 1404 can also include an operating system, application programs, other program modules, and program data.

The nonvolatile memory 1406 can be removable or non-removable. For example, the nonvolatile memory 1406 can be in the form of a removable memory card or a USB flash drive. In accordance with one aspect, the nonvolatile memory 1406 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1400 through input devices (not shown) such as a keypad, microphone, tablet or touch screen although other input devices can also be utilized. These and other input devices can be connected to the processor component 1402 through input interface component 1412 that can be connected to the system bus 1408. Other interface and bus structures, such as a parallel port, game port or a universal serial bus (USB) can also be utilized. A graphics subsystem (not shown) can also be connected to the system bus 1408. A display device (not shown) can be also connected to the system bus 1408 via an interface, such as output interface component 1412, which can in turn communicate with video memory. In addition to a display, the electronic device 1400 can also include other peripheral output devices such as speakers (not shown), which can be connected through output interface component 1412.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution as compared to software per se), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description may have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with data access patterns (e.g., prior device usage by one or more users, data/device/user contexts (e.g., amount of data, type of data, redundancy of data, prior data losses, ambient temperatures, battery performance, location of the user or device and/or proximity to known alternative power supplies, or combinations thereof, among many others), user interactions, progress of a process (e.g., determining allocation based in part on how far along in a process the user, device, or system is), or combinations thereof, among others, . . . ) and based in part in such evaluation, can render an inference, based in part on probability.

As an example, an inference can be formed relating to when to deploy an RFID antenna component based in part on the current contextual use of the device and the probability that that action will be appropriate. Similarly, an inference can be formed relating to when to pack an RFID antenna component, for example, based in part on the current time of day or battery condition and the probability that that action will be appropriate. In response to these inferences, actions can be undertaken to facilitate goals germane to the inferences formed. One of skill in the art will appreciate that intelligent and/or inferential systems, devices, and/or methodologies can facilitate further optimization of the disclosed subject matter and such inferences can be based on a large plurality of data and variables, all of which are considered within the scope of the disclosed subject matter.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates an improved from factor for a radio frequency identification (RFID) enabled mobile device (RFIDMD), comprising:
a mobile device component; and
a deployable RFID (DRFID) component deployably and communicatively interconnected with the mobile device component, such that the deployable RFID component can transition between at least one packed configuration and at least one deployed configuration.

2. The system of claim 1, wherein the DRFID further comprises at least an RFID antenna.

3. The system of claim 2, wherein the RFID antenna is at least one of an EPC Class 0 or EPC Class 1 type RFID antenna.

4. The system of claim 1, further comprising an intelligent component, wherein the intelligent component can, at least in part, form one or more inferences related to the packed configuration, the deployed configuration, a transitory configuration, or a combination thereof.

5. The system of claim 1, wherein the deployment modality comprises at least a hinge component.

6. The system of claim 1, wherein the deployment modality comprises at least a slide component.

7. The system of claim 1, wherein the deployment modality comprises at least a connector component.

8. The system of claim 1, wherein the deployment modality comprises at least one degree of freedom at one or more points of articulation.

9. The system of claim 1, wherein the volume of the extents of the three dimensional footprint of the packed configuration is less than the volume of the extents of the three dimensional footprint of the deployed configuration.

10. The system of claim 1, having a plurality of deployed configurations.

11. The system of claim 10, wherein transitions between at least two of the plurality of deployed configurations provides at least one of improved user ergonomics, reduced power consumption, improved RFID antenna directionality, improved RFID antenna range, or combinations thereof, during RFID related applications.

12. The system of claim 11, wherein transitions between the at least two deployed configurations is automatic.

13. The system of claim 1, having a plurality of packed configurations.

14. The system of claim 1, wherein at least a portion of a configuration transition is at least in part effected by at least one of manual actuation, mechanical actuation, electro-mechanical actuation, electric actuation, pneumatic actuation, magnetic actuation, electro-magnetic actuation, or some combination thereof.

15. An electronic device comprising at least the DRFID of claim 1.

16. An electronic device comprising the system of claim 1.

17. The system of claim 1, wherein the electronic device is a network connectable electronic device.

18. A method that facilitates transitions between a packed configuration and a deployed configuration of a RFIDMD comprising:
determining a need to transition between a packed configuration and a deployed configuration of a DRFID deployably and communicatively interconnected with a mobile device component; and
initiating the transition between the packed configuration and the deployed configuration of the DRFID deployably and communicatively interconnected with the mobile device component based, at least in part, on the determined need.

19. The method of claim 18, wherein the transition between the packed configuration and the deployed configuration further comprises at least one of a foldable modality, a slideable modality, a connector modality, or combinations thereof

20. A method that facilitates transitions between a packed configuration and a deployed configuration of a RFIDMD comprising:
inferring a need to transition between a packed configuration and a deployed configuration of a DRFID deployably and communicatively interconnected with a mobile device component; and
initiating the transition between the packed configuration and the deployed configuration of the DRFID deployably and communicatively interconnected with the mobile device component based, at least in part, on the inferred need.
